(19) United States
(12) Patent Application Publication
(10) Pub. No.: US 2015/0099051 A1
(43) Pub. Date: Apr. 9, 2015

(54) Method for making soup utilizing a seasoning bag

(71) Applicant: Edvinas Grigonis, Reno, NV (US)

(72) Inventor: Edvinas Grigonis, Reno, NV (US)

(21) Appl. No.: 13/998,183

(22) Filed: Oct. 9, 2013

(51) Int. Cl. B65D 85/808; A23L 1/40

(52) U.S. Cl. CPC B65D 85/808; A23L 1/40
USPC 426/589; 426/431

(57) ABSTRACT

The present invention is a method for making soup, stew or broth. The method utilizes a pre-filled seasoning bag of which is made from a liquid permeable material that allows flavor obtained from the spices and/or seasonings to escape there from yet retains the spices and/or seasonings therein while the soup is cooking. The seasoning bag may be sold independently or as a kit containing a variety of seasoning bags each containing a specific blend for preparing a specific soup, stew or broth. Also, the kit includes instructions for use of the seasoning bag and/or recipes therefore.

### FIELD OF THE INVENTION

The present invention relates in general to food products and preparation thereof but more particularly pertains to a method of making soup(s) which includes usage of a seasoning bag. The use of the seasoning bag is most advantageous and novel as this provides numerous advantages and flavorful results.

### BACKGROUND OF THE INVENTION

Throughout history culinary specialists and/or artists have developed numerous methods for preparing food products. All of which provide unique, novel and variable end results. Some of the various methods of preparation include, baking, broiling, sautéing, roasting, boiling etc. Each method is specifically used to achieve the desired result of a specialized food product. The present invention and method of preparation produces a flavorful soup, of which is extremely tantalizing to the taste buds. The resultant soup is also exceptionally healthy and rejuvenating when consumed.

### DESCRIPTION OF THE PRIOR ART

Within the known prior art methods for preparing soup, there are standard fundamental suggested instructions. The most common instruction is to include some type of spices and/or seasonings within the recipe. However, within each known current suggested instructions the spices and/or seasonings are added directly into the soup mixture, more particularly into the liquid concoction thereof. This is somewhat effective for obtaining flavor from the seasoning and/or spices but the result is a most undesirable problem while eating the soup. Namely, due to the fact that many seasonings and/or spices (if not crushed or in powder form) can be overwhelming when bitten, chewed and/or swallowed. For example, when eating soup or the like and one bite's into a garlic clove, a basil leaf, a chili pepper, or the like this can be terribly unpleasant, sometimes even taking ones breath away. Needless to say this can eliminate one's desire for eating soup. Therefore, a need exists for a method of preparing soup that allows for flavoring of the soup without adding the spices and/or seasonings directly into the soup mixture of liquid concoction thereof. The present invention resolves this issue by utilizing a pre-filled seasoning bag which contains therein all of the desired spices and/or seasonings. The pre-filled seasoning bag is easily added to the soup and/or liquid concoction thereof for the duration of cooking. Thereafter, the pre-filled seasoning bag can be easily removed yet the wonderful flavors obtained from the spices and/or seasonings have now been absorbed and remain within the soup. Thus, use of the pre-filled seasoning bag resolves a problem in a new, novel manner heretofore not addressed, recognized nor resolved within the known prior art.

### SUMMARY OF THE INVENTION

It is therefore a primary object of the present invention to provide a new and novel method for preparing soup(s) that resolves an undesirable issue heretofore not addressed or resolved.

It is a further object of the present invention to provide a pre-filled seasoning bag of which is made from a liquid permeable material that allows flavor obtained from the spices and/or seasonings to escape there from yet retains the spices and/or seasonings therein while the soup is cooking.

Yet another object of the present invention is to provide the above noted seasoning bag with pre-determined amounts of spices and/or seasonings therein.

Still another object of the present invention is to provide the last noted seasoning bag with spices and/or seasonings that are of a specific blend useful for preparing different varieties of soups of consumer choice.

A further object of the present invention is to provide a packaged product containing several pre-filled seasoning bags therein, each of which may be the same or a combination of various blends for variable soup recipes and the packaged product includes instructions and/or recipes.

Other objects and advantages will be seen when taken into consideration with the following specification.

### BRIEF DESCRIPTION OF THE DRAWINGS

FIG. 1 is substantially an overview depicting a first embodiment for the seasoning bag utilized within the method steps of the present invention.

FIG. 2 is substantially an overview depicting a second embodiment for the seasoning bag utilized within the method steps of the present invention.

FIG. 3 is substantially an overview depicting a third embodiment for the seasoning bag utilized within the method steps of the present invention.

FIG. 4 is substantially an overview depicting the seasoning bag and method of use.

FIG. 5 is substantially an overview depicting one embodiment for a packaged kit containing multiples of various seasoning bags.

### DETAILED DESCRIPTION OF THE DRAWINGS

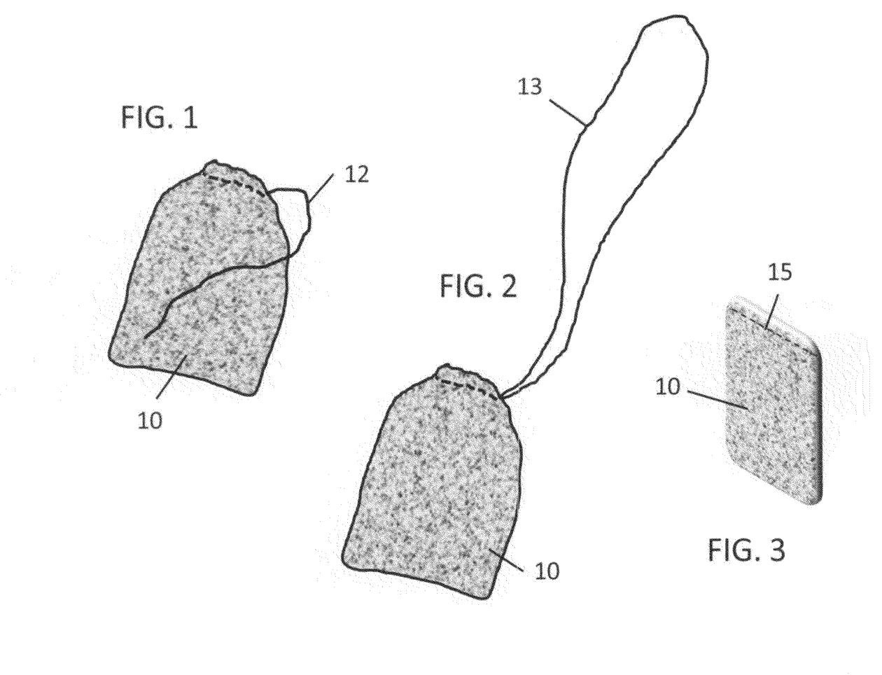

Referring now in detail to the drawings wherein like characters refer to like elements throughout the various views. As depicted within FIGS. 1-4 the general concept for the present invention includes a method for making soup utilizing a seasoning bag (10). It is to be understood the seasoning bag (10) can be made from substantially any suitable liquid permeable heat resistant material of engineering choice. For example, muslin, paper, cloth or the like of which is environmentally friendly and non-toxic. The seasoning bag (10) is pre-filled at the point of manufacture, with spices and/or seasonings of choice (not shown). Importantly, the seasoning bag and its contents are all natural and there is no need for any preservatives. Some examples of spices and/or seasonings include but are not limited to; at least one or more in combination such as substantially between 0.1 and 0.8 grams of either and/or salt, pepper, thyme, basil, cilantro, parsley, paprika, celery, marjoram, oregano, rosemary, dill, lovage, savory, sage, bay leaves, whole peppercorns, all spice, crushed peppers, whole peppers, cayenne, tarragon, fenugreek, turmeric, saffron, chili powder, cardamom, anise, celery powder chive and substantially between 1.00 and 4.00 grams of garlic and/or onion powder.

With further reference to the seasoning bag (10) it is to be noted it may be of any suitable size or shape and includes closure means of engineering choice. Thus, the seasoning bag as hereafter described is only exemplary and the invention is not to be limited thereto. As depicted in FIG. 1, the seasoning bag (10) is substantially in the shape of a bag having a drawstring (12) for a closure means. Thus the method steps are functional with the embodiment of FIG. 1 as follows:

Method for making soup utilizing a seasoning bag (10). The seasoning bag (10) being made from a liquid permeable material and is pre-filled with spices and/or seasonings. Thus, the soup resulting from the steps comprising:
(a) pouring a predetermined amount of a liquid into a stock pot (14);
(b) preparing various ingredients of choice;
(c) combining the liquid, the various ingredients of choice and the seasoning bag (10) producing in combination a soup mixture (18);
(d) cooking the soup mixture for a pre-determined amount of time; and;
(e) removing the seasoning bag (10) from said soup mixture (18) before serving the soup.

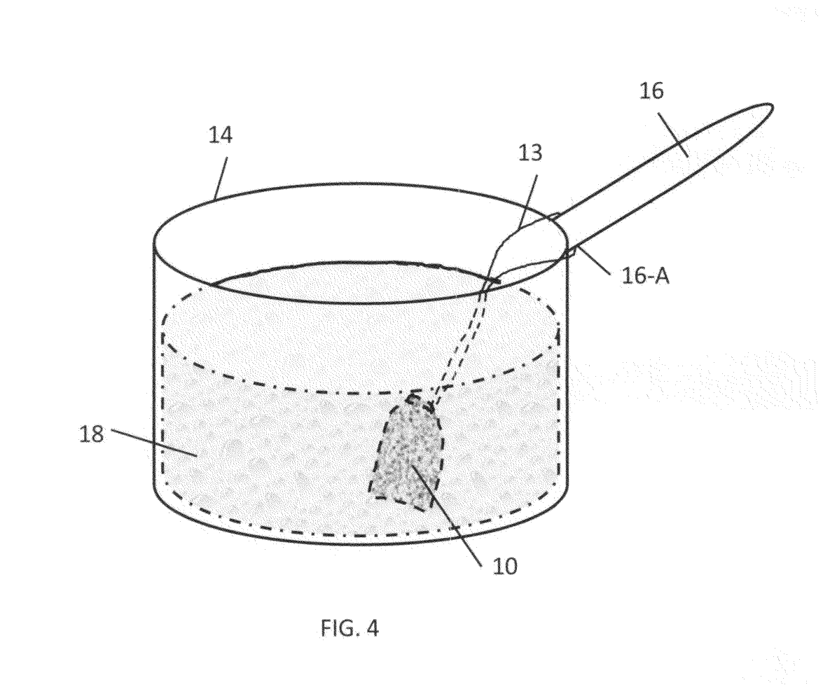

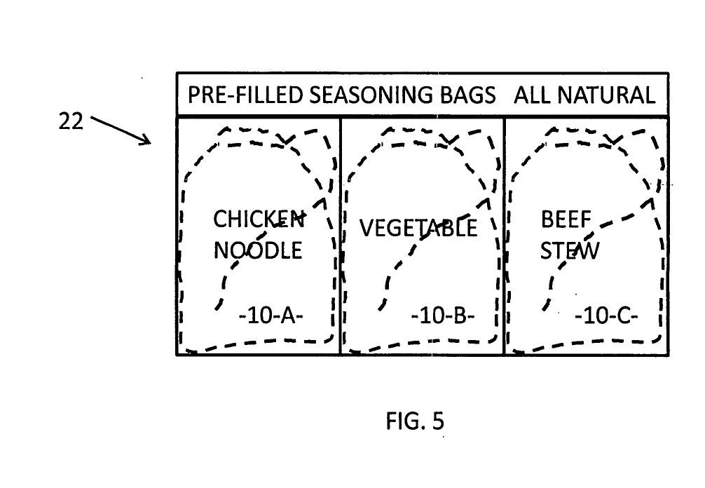

Within FIGS. 2 and 4, the seasoning bag (10) is substantially in the shape of a bag having an elongated loop (13) which is functional as the closure means as well. However, this second embodiment serves to facilitate the method of use. Whereby, as depicted in FIG. 4 and within the method steps as claimed, the stock pot (14) is shown having an outwardly extending handle (16) and the outwardly extending handle (16) having an attached end (16-A). As can be seen the elongated loop (13) is of a length to encircle the attached end (16-A) and extend downwardly into the stock pot (14). This embodiment is most advantageous and useful as it allows the user to easily remove the seasoning bag (10) after cooking and before serving the resultant soup. This resolves the cumbersome and somewhat frustrating issue of searching for the seasoning bag for removal after cooking. As a result this embodiment is included within the method steps and within the claims as follows:
(a) attaching the seasoning bag (10) onto the stock pot (14) by slide ably engaging the elongated loop (13) around the outwardly extending handle (16) until the elongated loop (13) encircles the attached end (16-A) of the outwardly extending handle (16), whereby the seasoning bag (10) dangles inside the stock pot (14);
(b) pouring a predetermined amount of liquid into the stock pot (14);
(c) preparing various ingredients of choice; such as any type of meat and/or vegetables, etc,
(d) combining the liquid, the various ingredients of choice and the seasoning bag (10) producing in combination a soup mixture (18) within the stock pot (14);
(e) cooking the soup mixture (18) for a pre-determined amount of time; and;
(f) removing the seasoning bag (10) from said soup mixture (18) before serving the soup.

Within FIG. 3, the seasoning bag (10) is substantially in the shape of a bag having optional closure means such as stitching (15) or the like. Again, it is to be noted and understood numerous types of closure means of engineering choice may be utilized such as staples, glue, zip-lock, etc.

It is also to be noted and understood that all types of soups, stews or broths can be prepared utilizing the seasoning bag (10) of the present invention depending on the end user's desires. However, for exemplary purposes the following method steps define a couple of examples of a particular soup recipe and preparation thereof.

A first example includes a method for making chicken soup utilizing a seasoning bag (10) the seasoning bag (10) being made from a liquid permeable material and is pre-filled with basil, green peppercorn, black peppercorn, white peppercorn, all spices, bay leaves, dill, chives, thyme, garlic, marjoram, parsley, lovage, sage, oregano, fenugreek and savory in combination and chicken soup resulting from the steps comprising:
(a) sautéing celery and onions together in butter within a stock pot (14);
(b) adding chopped cooked chicken meat, carrots, water and the seasoning bag (10) to the stock pot (14) producing a soup mixture (18);
(c) simmering the soup mixture (18) for about 30 minutes or for another a pre-determined amount of time;
(d) adding noodles to the soup mixture (18);
(e) simmering the soup mixture (18) for about 10 minutes or for another additional pre-determined amount of time; and;
(f) removing the seasoning bag (10) from the soup mixture before serving the soup.

A second example includes a method for making vegan soup utilizing a seasoning bag (10) the seasoning bag (10) being made from a liquid permeable material and is pre-filled with basil, green peppercorn, black peppercorn, white peppercorn, all spices, bay leaves, dill, chives, thyme, garlic, marjoram, parsley, lovage, sage, oregano, fenugreek and savory in combination and vegan soup resulting from the steps comprising:
(a) sautéing celery and onions together in butter within a stock pot (14);
(b) adding tofu, carrots, water and the seasoning bag (10) to the stock pot (14) producing a soup mixture (18);
(c) simmering the soup mixture (18) for about 30 minutes or for another a pre-determined amount of time;
(d) adding noodles to the soup mixture (18);
(e) simmering the soup mixture (18) for about 10 minutes or for another additional pre-determined amount of time; and;
(f) removing the seasoning bag (10) from the soup mixture before serving the vegan soup.

A third example includes a method for making vegetable beef soup or stew utilizing a seasoning bag (10) the seasoning bag (10) being made from a liquid permeable material and is pre-filled with basil, rosemary, bay leaves, all spices, parsley, garlic, smoked paprika, chili powder, cilantro, bay leaves, peppercorn mix and cloves in combination and the vegetable beef soup or stew resulting from the steps comprising:
(a) browning beef in oil within a stock pot (14);
(b) adding a predetermined amount of a liquid, Worcestershire sauce and the spice bag (10) into the stock pot (14);
(c) simmering for a predetermined amount of time such as 1½ hours;
(d) adding various ingredients of choice, such as carrots, celery, beans and tomatoes;
(e) cooking for an additional predetermined amount of time such as 30 to 40 minutes resulting in a soup mixture;
(f) removing substantially 2 cups of liquid from the soup mixture;
(g) blending water with cornstarch in a bowl resulting in a thickening agent;
(h) mixing the thickening agent with some of the liquid from the soup mixture resulting in a thickening mixture;
(i) adding the thickening mixture to the soup mixture until blended well; and;
(g) removing the seasoning bag (10) from the soup mixture before serving the vegetable beef soup or stew.

In reference to FIG. 4 wherein one embodiment is depicted illustrating a packaged kit (22) containing multiples of various seasoning bags (10-A), (10-B) and (10-C). Whereby, a consumer can purchase the kit (22) containing a variety of seasoning bags in combination for making several different types of soups or stews of choice. For example the kit (22) may contain a first seasoning bag (10-A) for making chicken noodle soup with the seasoning bag (10-A) being pre-filled with basil, green peppercorn, black peppercorn, white peppercorn, all spices, bay leaves, dill, chives, thyme, garlic, marjoram, parsley, lovage, sage, oregano, fenugreek and savory in combination. The kit further includes a second seasoning bag (10-B) for making vegetable soup with the seasoning bag (10-B) being pre-filled oregano basil, chive, cilantro, parsley, thyme, paprika, all spice, peppercorn mix, marjoram, onion, garlic, sage, savory, turmeric, lovage and dill in combination. The kit also includes a third seasoning bag (10-C) for making beef stew with the seasoning bag (10-B) being pre-filled basil, rosemary, bay leaves, all spices, parsley, garlic, smoked paprika, chili powder, cilantro, bay leaves, peppercorn mix and cloves in combination.

It can now be seen herein provided is a method of making soup(s) which includes usage of a seasoning bag. The use of the seasoning bag is most advantageous and novel as this provides numerous advantages and flavorful results.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described the invention, what I claim as new and desire to secure by LETTERS PATENT is:

1. Method for making soup utilizing a seasoning bag, said seasoning bag being made from a liquid permeable material, said seasoning bag being pre-filled with spices and/or seasonings, said soup resulting from the steps comprising:
(a) pouring a predetermined amount of a liquid into a stock pot;
(b) preparing various ingredients of choice;
(c) combining said liquid, said various ingredients of choice and said seasoning bag producing in combination a soup mixture;
(d) cooking said soup mixture for a pre-determined amount of time; and;
(e) removing said seasoning bag from said soup mixture before serving said soup.

2. The method according to claim 1 wherein said spices and/or seasonings include at least one or more thereof in combination comprising: substantially between 0.1 and 0.8 grams of either and/or salt, pepper, thyme, basil, cilantro, parsley, paprika, celery, marjoram, oregano, rosemary, dill, lovage, savory, sage, bay leaves, whole peppercorns, all spice, crushed peppers, whole peppers, cayenne, tarragon, fenugreek, turmeric, saffron, chili powder, cardamom, anise, celery powder chive and substantially between 1.00 and 4.00 grams of garlic and/or onion powder.

3. Method for making soup utilizing a seasoning bag, said seasoning bag being made from a liquid permeable material, said seasoning bag being pre-filled with spices and/or seasonings, said seasoning bag having an elongated loop, a stock pot having an outwardly extending handle, said outwardly extending handle having an attached end, said elongated loop being of a length to encircle said attached end and extend downwardly into said stock pot, said soup resulting from the steps comprising:
(a) attaching said seasoning bag onto said stock pot by slide ably engaging said elongated loop around said outwardly extending handle until said elongated loop encircles said attached end of said outwardly extending handle whereby said seasoning bag dangles inside said stock pot;
(b) pouring a predetermined amount of liquid into said stock pot;
(c) preparing various ingredients of choice;
(d) combining said liquid, said various ingredients of choice and said seasoning bag producing in combination a soup mixture within said stock pot;
(e) cooking said soup mixture for a pre-determined amount of time; and;
(f) removing said seasoning bag from said soup by slide ably disengaging said elongated loop from said attached end then lifting upwards and out of said soup mixture before serving said soup.

4. The method according to claim 3 wherein said spices and/or seasonings include at least one or more thereof in combination comprising: substantially between 0.1 and 0.8 grams of either and/or salt, pepper, thyme, basil, cilantro, parsley, paprika, celery, marjoram, oregano, rosemary, dill, lovage, savory, sage, bay leaves, whole peppercorns, all spice, crushed peppers, whole peppers, cayenne, tarragon, fenugreek, turmeric, saffron, chili powder, cardamom, anise, celery powder chive and substantially between 1.00 and 4.00 grams of garlic and/or onion powder.

5. Method for making chicken soup utilizing a seasoning bag, said seasoning bag being made from a liquid permeable material, said seasoning bag being pre-filled with Basil , green peppercorn, black peppercorn, white peppercorn, all spices, bay leaves, dill, chives , thyme, garlic, marjoram, parsley, lovage, sage, oregano, fenugreek and savory in combination, said chicken soup resulting from the steps comprising:
(a) sautéing celery and onions together in butter within a stock pot;
(b) adding chopped cooked chicken meat, carrots, water and said seasoning bag to said stock pot producing a soup mixture;
(c) simmering said soup mixture for a pre-determined amount of time;
(d) adding noodles to said soup mixture;
(e) simmering said soup mixture for an additional pre-determined amount of time; and;
(f) removing said seasoning bag from said soup mixture before serving said chicken soup.

6. The method according to claim 5 wherein said chopped cooked chicken meat is eliminated and replaced with tofu resulting in a vegan soup.

7. The method according to claim 1 wherein multiples of said seasoning bag are packaged and sold as a kit.

8. The method according to claim 7 wherein said multiples of said seasoning bag contains different combinations or specific blends of said spices and/or seasonings for use in making various types of soup, stew or broth.
